(19) United States
(12) Patent Application Publication
(10) Pub. No.: US 2014/0015772 A1
(43) Pub. Date: Jan. 16, 2014

(54) FLEXIBLE TOUCH-SENSING DISPLAY PANEL

(71) Applicant: HANNSTOUCH SOLUTION INCORPORATED, Tainan City (TW)

(72) Inventors: Kuo-Hsiung Tung, Taoyuan County (TW); Pin-Yu Hsu, Tainan City (TW); Chuan-Hui Su, Kaohsiung City (TW)

(73) Assignee: HANNSTOUCH SOLUTION INCORPORATED, Tainan City (TW)

(21) Appl. No.: 13/720,940

(22) Filed: Dec. 19, 2012

(30) Foreign Application Priority Data
Jul. 12, 2012 (TW) 101125144

(51) Int. Cl. G06F 3/041

(52) U.S. Cl. CPC G06F 3/041
USPC 345/173

(57) ABSTRACT

The present invention provides a flexible touch-sensing display panel including a flexible display panel, a flexible transparent substrate and a first patterned transparent conductive layer. The flexible display panel has a display surface, and the flexible transparent substrate is disposed on the display surface of the flexible display panel. The flexible transparent substrate has a first surface and a second surface disposed opposite to each other, and the first patterned transparent conductive layer is disposed on the first surface of the flexible transparent substrate.

### BACKGROUND OF THE INVENTION

1. Field of the Invention

The present invention relates to a touch-sensing display panel, and more particularly, to a flexible touch-sensing display panel.

2. Description of the Prior Art

Touch-sensing display panel is an input device, and contents displayed on a screen of an image display device in the touch-sensing display panel can be selected by human's hand or an object to input user's indication. The touch-sensing display panel can provide a function of transferring a touch of the human's hand or the object at a position of the front of the image display device to be an electrical signal, and the touch to the position of the image display device corresponding to a command can serve as an input signal to execute the function of the command. Thus, the touch-sensing display panel can replace extra input devices, such as keyboard and mouse, coupled to the image display device, and the using range can also be increased. However, the conductive materials in traditional touch-sensing display panel and the liquid crystal display panel cannot operate after bending. Accordingly, the touch-sensing display panel should be manufactured by hard substrate, and thereby, only can be applied to hard flat computers. The size of the touch-sensing display panel is also limited by the hard substrate that results in inconvenience of user. To provide a flexible touch-sensing display panel is an objective in this field.

### SUMMARY OF THE INVENTION

It is therefore an objective of the present invention to provide a flexible touch-sensing display panel to solve the above problem in the prior art.

According to an embodiment, the present invention provides a flexible touch-sensing display panel includes a flexible display panel, a first flexible transparent substrate and a first patterned transparent conductive layer. The flexible display panel has a display surface. The first flexible transparent substrate is disposed on the display surface of the first flexible display panel, and the first flexible transparent substrate has a first surface and a second surface disposed opposite to each other. The first patterned transparent conductive layer is disposed on the first surface of the first flexible transparent substrate.

The flexible touch display panel of the present invention uses at least one flexible transparent substrate to form two patterned transparent conductive layers, and the flexible touch-sensing panel can have the flexible characteristic accordingly. Furthermore, the flexible touch display panel can therefore have the flexible characteristic in combination with the flexible display panel.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating an exploded cross-sectional view of a flexible touch-sensing display panel according to a first embodiment of the present invention.

FIG. 2 is a schematic diagram illustrating a top view of the flexible touch-sensing display panel according to the first embodiment of the present invention.

FIG. 3 is a schematic diagram illustrating an exploded cross-sectional view of a flexible touch-sensing display panel according to a second embodiment of the present invention.

FIG. 4 is a schematic diagram illustrating an exploded cross-sectional view of a flexible touch-sensing display panel according to a third embodiment of the present invention.

FIG. 5 is a schematic diagram illustrating an exploded cross-sectional view of a flexible touch-sensing display panel according to a fourth embodiment of the present invention.

FIG. 6 is a schematic diagram illustrating an exploded cross-sectional view of a flexible touch-sensing display panel according to a fifth embodiment of the present invention.

FIG. 7 is a schematic diagram illustrating an exploded cross-sectional view of a flexible touch-sensing display panel according to a sixth embodiment of the present invention.

### DETAILED DESCRIPTION

To provide a better understanding of the present invention, exemplary embodiments will be detailed as follows. The exemplary embodiments of the present invention are illustrated in the accompanying drawings with numbered elements to elaborate the contents and effects to be achieved.

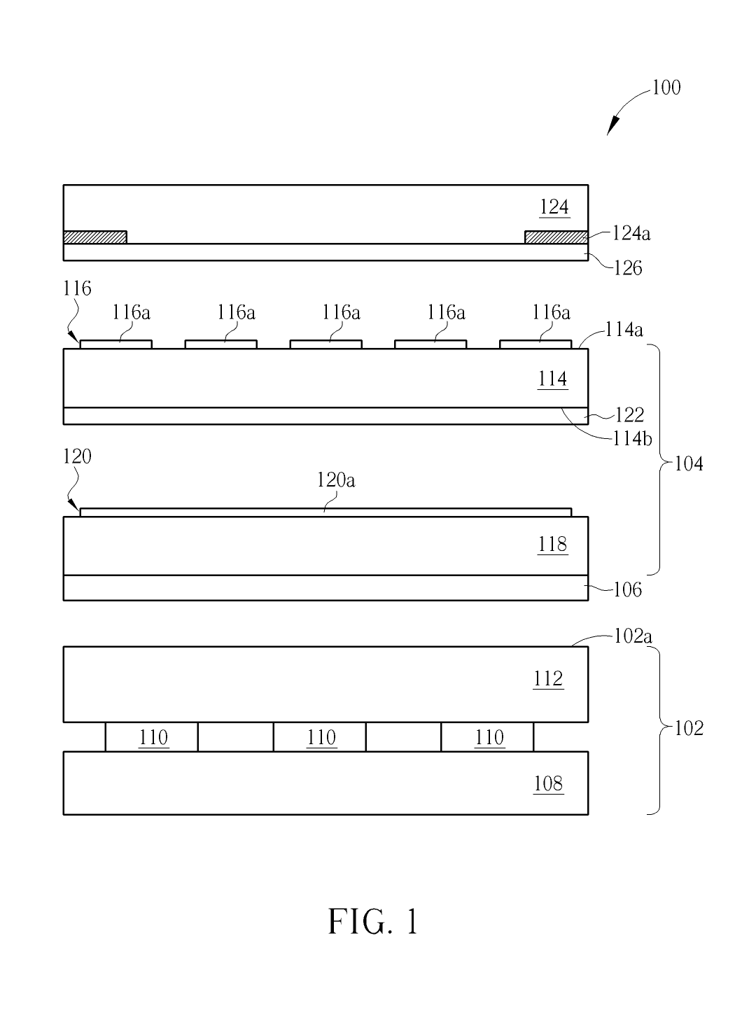

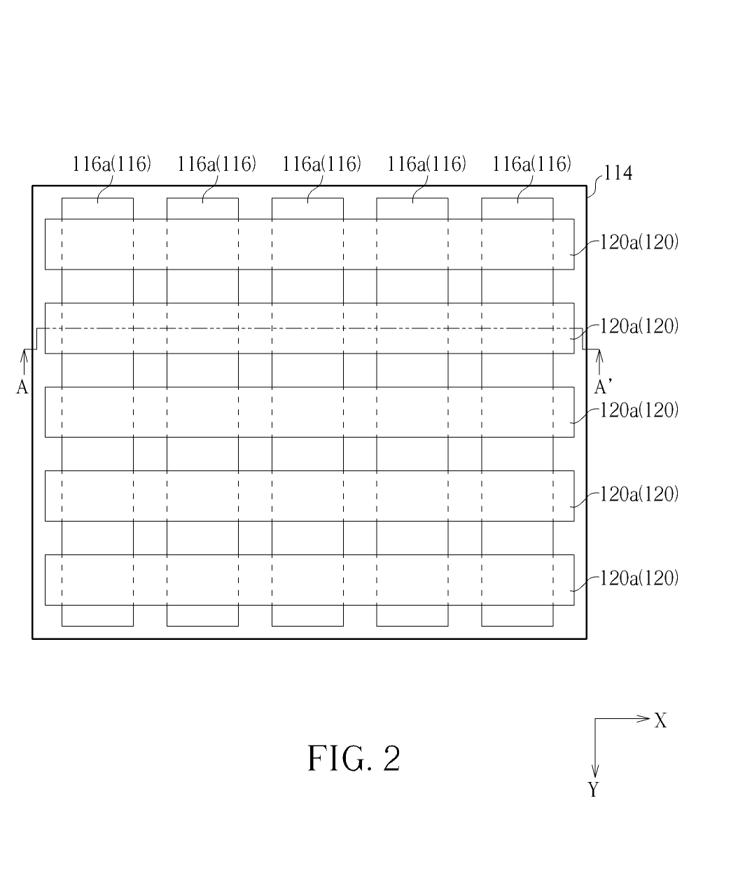

Please refer to FIG. 1 and FIG. 2. FIG. 1 is a schematic diagram illustrating an exploded cross-sectional view of a flexible touch-sensing display panel according to a first embodiment of the present invention, and FIG. 2 is a schematic diagram illustrating a top view of the flexible touch-sensing display panel according to the first embodiment of the present invention, wherein FIG. 1 is the exploded cross-sectional view of FIG. 2 taken along a cross-sectional line A-A′. As shown in FIG. 1, the flexible touch-sensing display panel 100 includes a flexible display panel 102, a flexible touch-sensing panel 104, and a first adhesive layer 106. The flexible display panel 102 has a display surface 102a, and is configured to display images. The flexible touch-sensing panel 104 is disposed on the display surface 102a of the flexible display panel 102. The adhesive layer 106 is disposed between the flexible display panel 102 and the flexible touch-sensing panel 104, and covers the flexible touch-sensing panel 104, so that the flexible touch-sensing panel 104 can adhere to the flexible display panel 102 by the first adhesive layer 106. In this embodiment, the flexible display panel 102 can include an organic light-emitting diode display panel, an electronic paper display or a polymer light-emitting diode display panel, but the present invention is not limited to this. The flexible display panel 102 includes a flexible substrate 108, an organic light-emitting diode layer 110, and a flexible protective substrate 112. The organic light-emitting diode layer 110 is disposed on the flexible substrate 108, and the flexible protective substrate 112 is disposed on and covers the organic light-emitting diode 110. Since the flexible substrate 108, the organic light-emitting diode layer 110 and the flexible protective substrate 112 have a flexible characteristic, the flexible display panel 102 can have the flexible characteristic. The flexible substrate 108 of this embodiment can be formed by a flexible material, such as polyethylene terephthalate (PET), cycllolefin copolymer (COC) or polycarbonate (PC). The flexible protective substrate 112 can be formed by a transparent and flexible material, such as PET. The materials of the flexible substrate 108 and the flexible protective substrate 112 in the present invention are not limited to the above-mentioned description.

In this embodiment, the flexible touch-sensing panel 104 includes a first flexible transparent substrate 114, a first patterned transparent conductive layer 116, a second flexible transparent substrate 118, a second patterned transparent conductive layer 120, and a second adhesive layer 122. The first flexible transparent substrate 114 is disposed on the display surface 102a of the flexible display panel 102, and the first flexible transparent substrate 114 has a first surface 114a and a second surface 114b disposed opposite to each other. The second surface 114b faces the flexible display panel 102, and the first patterned transparent conductive layer 116 is disposed on the first surface 114a of the first flexible transparent substrate 114. The first patterned transparent conductive layer 116 is directly formed on the first flexible transparent substrate 114 by a deposition process, but the present invention is not limited herein. The second flexible transparent substrate 118 is disposed between the second surface 114b of the first flexible transparent substrate 114 and the display surface 102a of the flexible display panel 102, and the second patterned transparent conductive layer 120 is disposed on a surface of the second flexible transparent substrate 114 facing the first flexible transparent substrate 114. Accordingly, the first flexible transparent substrate 114 can be disposed between the first patterned transparent conductive layer 116 and the second patterned transparent conductive layer 120 to insulate the first patterned transparent conductive layer 116 and the second patterned transparent conductive layer 120. The second patterned transparent conductive layer 120 also can be directly formed on the second flexible transparent substrate 118 by another deposition process, but the present invention is not limited herein. The second adhesive layer 122 is disposed between the first flexible transparent substrate 114 and the second flexible transparent substrate 118, and covers the first flexible transparent substrate 114, so that the second adhesive layer 122 can be configured to attach the first flexible transparent substrate 114 to the second flexible transparent substrate 118.

It should be noted that the first flexible transparent substrate 114 and the second flexible transparent substrate 118 can be respectively formed by a transparent and flexible material, such as PET, and have the flexible characteristic. Furthermore, the first patterned transparent conductive layer 116 and the second patterned transparent conductive layer 120 can respectively includes a flexible conductive material, such as indium tin oxide (ITO), indium zinc oxide (IZO), zinc oxide (ZnO), zinc gallium oxide (ZnGaO), graphene, conductive polymer, carbon nanotube (CNT), indium-tin-oxide nanoparticles, micro-scale metal wires, metal nanowires or organic material, and has the flexible characteristic accordingly. Thus, when the flexible touch-sensing panel 104 bends, and a bended angle of the flexible touch-sensing panel 104 is even to be about 180 degree, the first patterned transparent conductive layer 116 and the second patterned transparent conductive layer 120 won't be broken, and no broken circuit will be generated. The metal nanowires can include silver or copper, and the micro-scale metal wires can include silver or copper, but the present invention is not limited to this. Furthermore, the first adhesive 106 and the second adhesive layer 122 can be respectively formed by a transparent and adhesive material, such as optical clear adhesive or water soluble glue, but the present invention is not limited to this.

In addition, the flexible touch display panel 100 of this embodiment further includes a decoration film 124 and a third adhesive layer 126, and the decoration film 124 and the third adhesive layer 126 are disposed on the first surface 114a of the first flexible transparent substrate 114. The third adhesive layer 126 is disposed between the first flexible transparent substrate 114 and the decoration film 124 and covers the first flexible transparent substrate 114, and thereby attaches the decoration film 124 to the first flexible transparent substrate 114. The decoration film 124 has a light-shielding pattern 124a configured to shield opaque devices, such as peripheral circuits, disposed in the flexible touch-sensing panel 104, and an appearance of the flexible touch display panel 100 can therefore be beautified. The decoration film 124 also has the flexible characteristic. Furthermore, the first adhesive layer 106, the second adhesive layer 122 and the third adhesive layer 126 cover the first patterned transparent conductive layer 116 and the second patterned transparent conductive layer 120, so that the patterns of the first patterned transparent conductive layer 116 and the second patterned transparent conductive layer 120 will not be easily seen by users, and image quality displayed by the flexible display panel 102 will not be affected.

As the above-mentioned description, since the flexible touch-sensing panel 104 of this embodiment includes the first flexible transparent substrate 114, the second flexible transparent substrate 118, the first patterned transparent conductive layer 116, and the second patterned transparent conductive layer 118 that have the flexible characteristic, the flexible touch-sensing panel 104 can have the flexible characteristic. Thus, the flexible touch display panel 100 of this embodiment has the flexible characteristic due to the flexible touch-sensing panel 104 and the flexible display panel 102 both having the flexible characteristic.

Please refer to FIG. 2 together with FIG. 1. The flexible touch-sensing panel 104 of this embodiment includes a capacitive type touch-sensing panel, but the present invention is not limited to this. The first patterned transparent conductive layer 116 can include a plurality of first sensing electrodes 116a arranged in parallel and sequentially along a first direction X. The second patterned transparent conductive layer 120 can include a plurality of second sensing electrodes 120a arranged in parallel and sequentially along a second direction Y different from the first direction X. The first sensing electrodes 116a cross the second sensing electrodes 120a, so that the first sensing electrodes 116a can be configured to sense a position of an object touching the flexible touch-sensing panel 104 in the first direction X, and the second sensing electrodes 120a can be configured to sense a position of the object touching the flexible touch-sensing panel 104 in the second direction Y. In this embodiment, the first direction X is perpendicular to the second direction Y, but the present invention is not limited herein. Furthermore, each first sensing electrode 116a and each second sensing electrode 120a are stripe-shaped, but are not limited herein. In other embodiment of the present invention, each first sensing electrode and each second sensing electrode also can be respectively a series formed by a plurality of square, diamond or hexagonal pads. Also, the arranged direction of the first sensing electrodes and the arranged direction of the second sensing electrodes can be exchanged.

The flexible touch display panel of the present invention is not limited to the above-mentioned embodiment. The following description continues to detail the other embodiments or modifications, and in order to simplify and show the difference between the other embodiments or modifications and the above-mentioned embodiment, the same numerals denote the same components in the following description, and the same parts are not detailed redundantly.

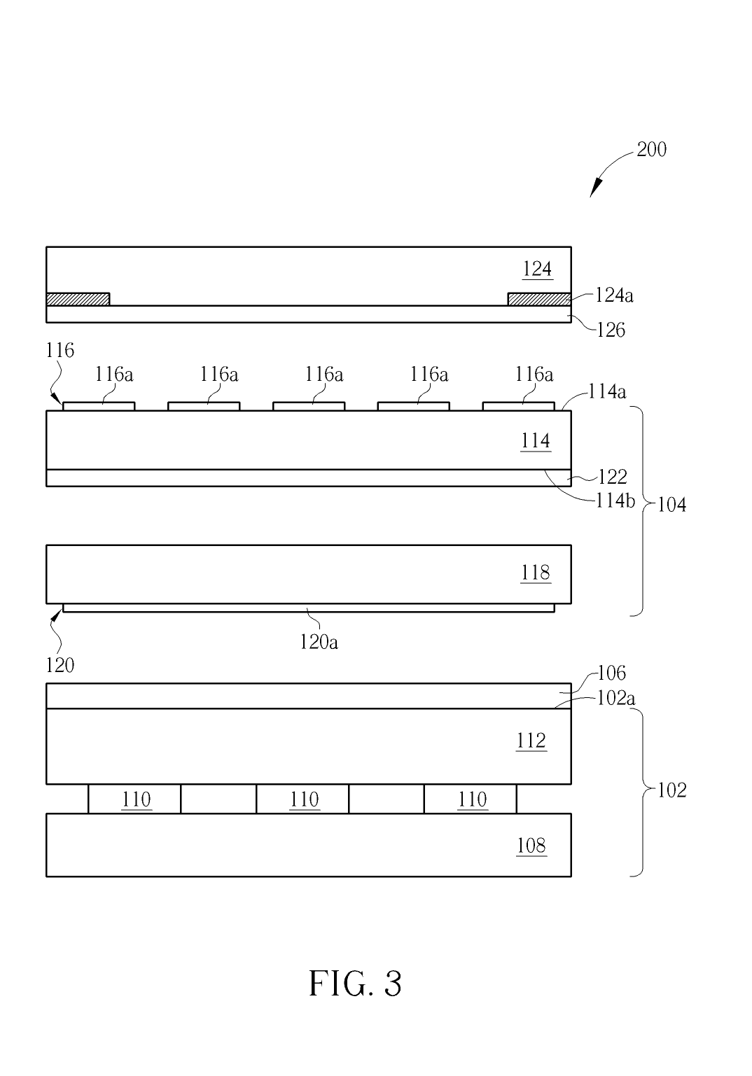

Please refer to FIG. 3, which is a schematic diagram illustrating an exploded cross-sectional view of a flexible touch-sensing display panel according to a second embodiment of the present invention. As shown in FIG. 3, compared with first embodiment, the second patterned transparent conductive layer 120 of the flexible touch display panel 200 in this embodiment is disposed on a surface of the second flexible transparent substrate 118 facing the flexible display panel 102.

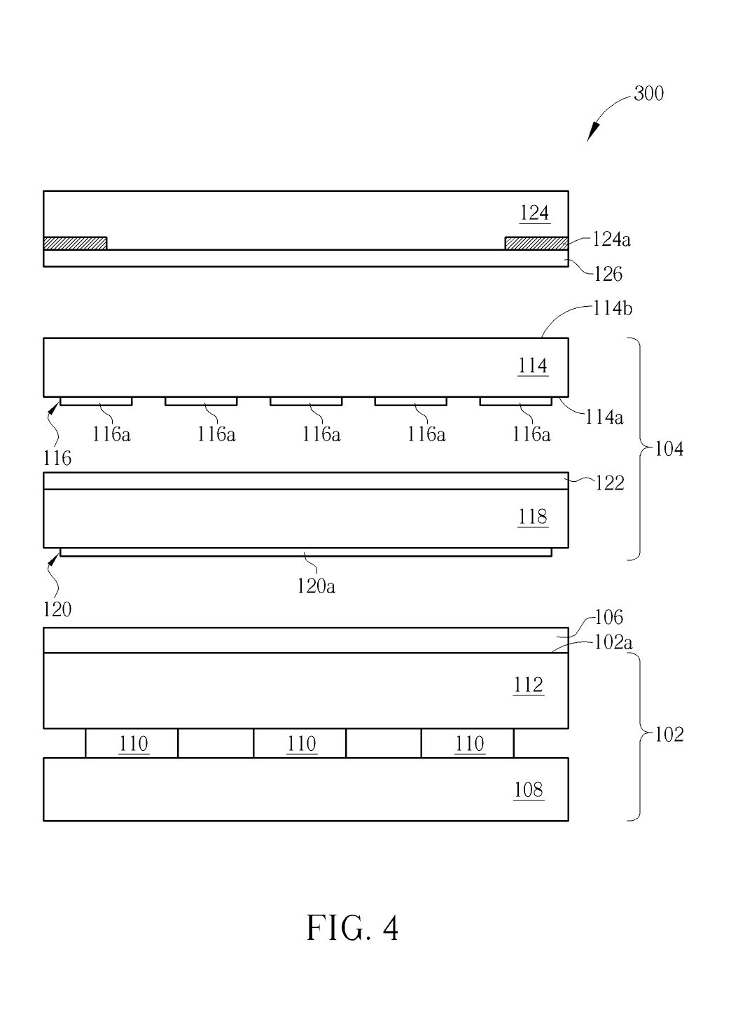

Please refer to FIG. 4, which is a schematic diagram illustrating an exploded cross-sectional view of a flexible touch-sensing display panel according to a third embodiment of the present invention. As shown in FIG. 4, the first surface 114a of the first flexible transparent substrate 114 of the flexible touch display panel 300 in the this embodiment faces the display surface 102a of the flexible display panel 102, and the second flexible transparent substrate 118 is disposed between the first surface 114a of the first flexible transparent substrate 114 and the display surface 102a of the flexible display panel 102 as compared with the first embodiment. Furthermore, the first patterned transparent conductive layer 116 is disposed on the first surface 114a of the first flexible transparent substrate 114 and between the first flexible transparent substrate 114 and the second flexible transparent substrate 118. The second patterned conductive layer 120 is disposed on a surface of the second flexible transparent substrate 118 facing the flexible display panel 102, and the second flexible transparent substrate 118 can be accordingly disposed between the first patterned transparent conductive layer 116 and the second patterned transparent conductive layer 120 to insulate the first patterned transparent conductive layer 116 from the second patterned transparent conductive layer 120.

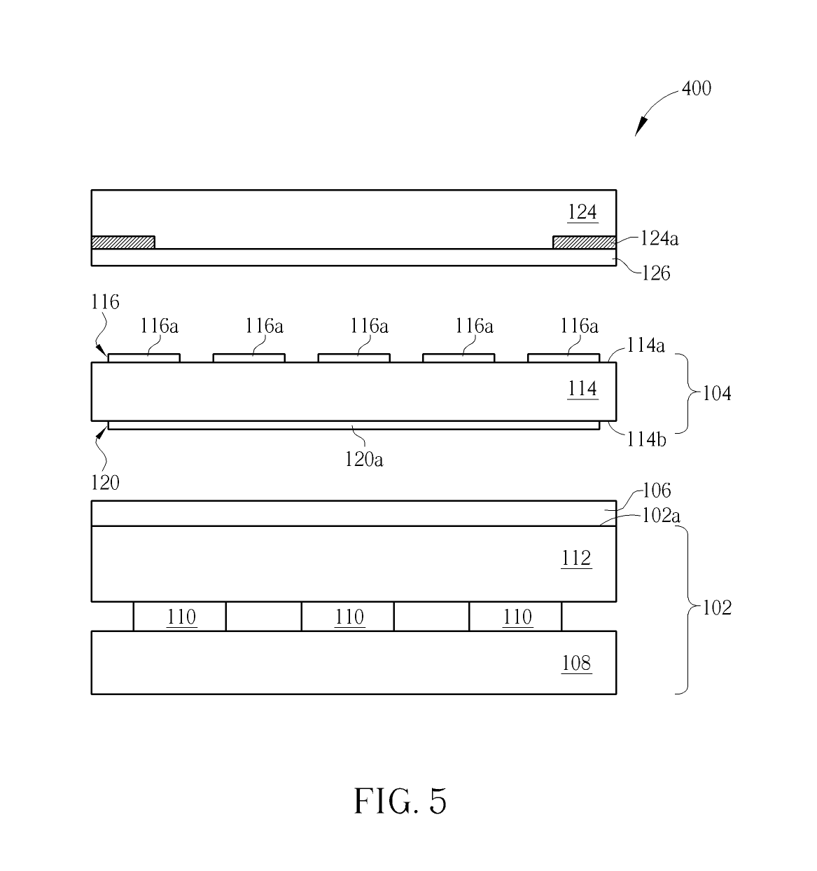

Please refer to FIG. 5, which is a schematic diagram illustrating an exploded cross-sectional view of a flexible touch-sensing display panel according to a fourth embodiment of the present invention. As shown in FIG. 5, compared with the first embodiment, the flexible touch display panel 400 do not include the second flexible transparent substrate, and the second patterned transparent conductive layer 120 is directly disposed on the second surface 114b of the first flexible transparent substrate 114 in this embodiment.

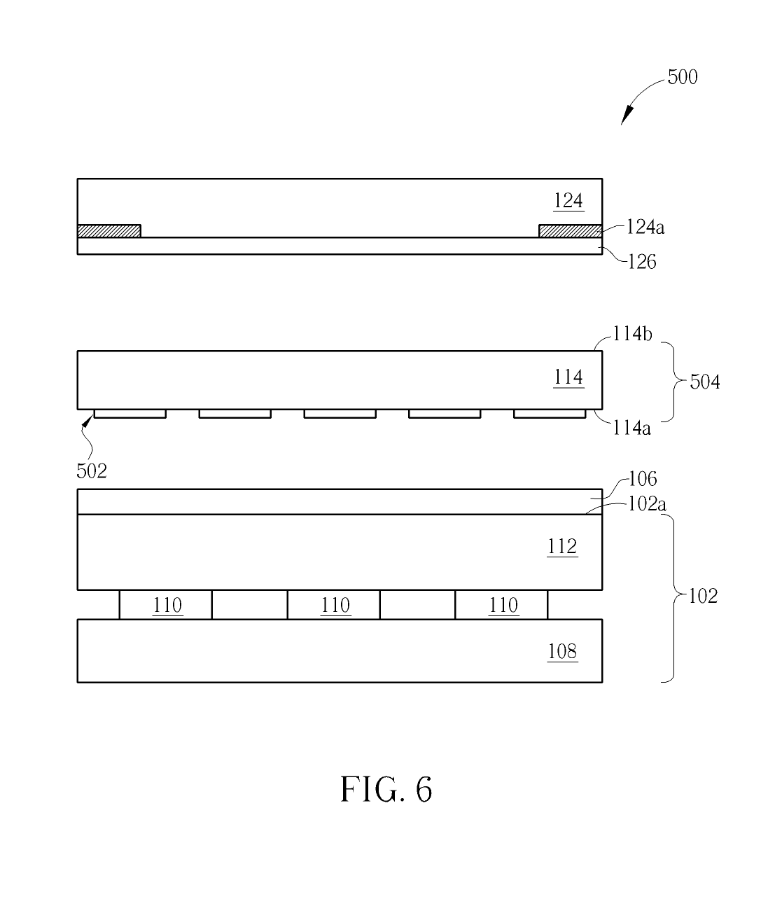

Please refer to FIG. 6, which is a schematic diagram illustrating an exploded cross-sectional view of a flexible touch-sensing display panel according to a fifth embodiment of the present invention. As shown in FIG. 6, as compared with the fourth embodiment, the flexible touch display panel 500 can only include one patterned transparent conductive layer 502 in this embodiment, that is to say, the flexible touch-sensing panel 504 is only formed by the patterned transparent conductive layer 502 and the first flexible transparent substrate 114, and the patterned transparent conductive layer 502 is disposed on the first surface 114a of the first flexible transparent substrate 114. In this embodiment, the first surface 114a faces the display surface 102a of the flexible display panel 102. Furthermore, the patterned transparent conductive layer 502 can be used to sense a position of an object touching the flexible touch-sensing panel 504 in the first direction X and in the second direction Y together.

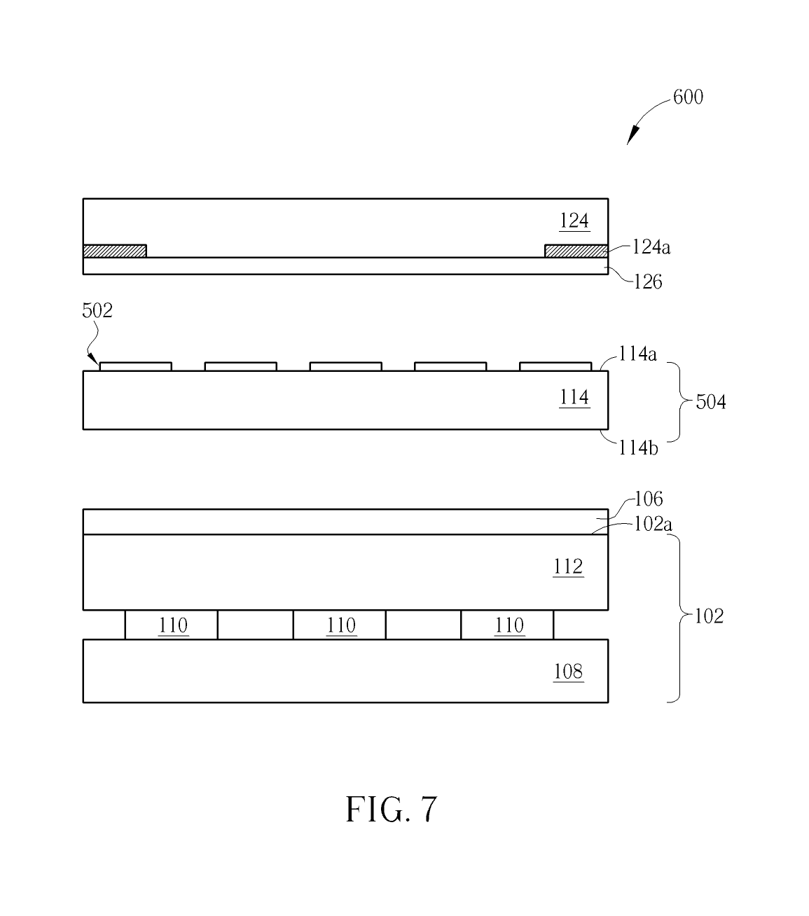

Please refer to FIG. 7, which is a schematic diagram illustrating an exploded cross-sectional view of a flexible touch-sensing display panel according to a sixth embodiment of the present invention. As shown in FIG. 7, as compared with the fifth embodiment, the first surface 114a of the first flexible transparent substrate 114 in the flexible touch display panel 600 of this embodiment faces the decoration film 124. That is to say, the patterned transparent conductive layer 502 is disposed between the first flexible transparent substrate 114 and the decoration film 124, and the flexible touch-sensing panel 504 is also only formed by the patterned transparent conductive layer 502 and the first flexible transparent substrate 114.

In summary, the flexible touch display panel of the present invention uses at least one flexible transparent substrate to form two patterned transparent conductive layers, and the flexible touch-sensing panel can have the flexible characteristic accordingly. Furthermore, the flexible touch display panel can therefore have the flexible characteristic in combination with the flexible display panel.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A flexible touch-sensing display panel, comprising:
a flexible display panel, having a display surface;
a first flexible transparent substrate, disposed on the display surface of the first flexible display panel, and the first flexible transparent substrate having a first surface and a second surface disposed opposite to each other; and
a first patterned transparent conductive layer, disposed on the first surface of the first flexible transparent substrate.

2. The flexible touch-sensing display panel according to claim 1, wherein the second surface faces the display surface.

3. The flexible touch-sensing display panel according to claim 2, further comprising a second patterned transparent conductive layer, disposed on the second surface of the first flexible transparent substrate and electrically insulated from the first patterned transparent conductive layer.

4. The flexible touch-sensing display panel according to claim 2, further comprising a second patterned transparent conductive layer and a second flexible transparent substrate, the second flexible transparent substrate being disposed between the first flexible transparent substrate and the flexible display panel, and the second patterned transparent conductive layer being disposed on a surface of the second flexible transparent substrate facing the first flexible transparent substrate.

5. The flexible touch-sensing display panel according to claim 2, further comprising a second patterned transparent conductive layer and a second flexible transparent substrate, the second flexible transparent substrate being disposed between the first flexible transparent substrate and the flexible display panel, and the second patterned transparent conductive layer being disposed on a surface of the second flexible transparent substrate facing the display surface.

6. The flexible touch-sensing display panel according to claim 1, wherein the first surface faces the display surface.

7. The flexible touch-sensing display panel according to claim 6, further comprising a second patterned transparent conductive layer and a second flexible transparent substrate, the second patterned transparent conductive layer being disposed on a surface of the second flexible transparent substrate facing the display surface.

8. The flexible touch-sensing display panel according to claim 1, wherein the first patterned transparent conductive layer comprise a flexible conductive material.

9. The flexible touch-sensing display panel according to claim 8, wherein the flexible conductive material comprises indium tin oxide, indium zinc oxide, zinc oxide, zinc gallium oxide, graphene, conductive polymer, carbon nanotube, indium-tin-oxide nanoparticles, micro-scale metal wires or metal nanowires.

10. The flexible touch-sensing display panel according to claim 9, wherein the metal nanowires comprise silver or copper.

11. The flexible touch-sensing display panel according to claim 9, wherein the micro-scale metal wires comprise silver or copper.

12. The flexible touch-sensing display panel according to claim 1, wherein the flexible display panel comprises an organic light-emitting diode display panel, an electronic paper display or a polymer light-emitting diode display panel.
